(19) United States
(12) Patent Application Publication
(10) Pub. No.: US 2003/0063694 A1
(43) Pub. Date: Apr. 3, 2003

(54) Automatic frequency control of GMSK time-dispersive channels

(76) Inventors: Mark A. Goldberg, Plantation, FL (US); Stephen Carsello, Plantation, FL (US); Brett L. Robertson, Mundelein, IL (US)

Correspondence Address: MOTOROLA, INC, INTELLECTUAL PROPERTY SECTION, LAW DEPT, 8000 WEST SUNRISE BLVD, FT LAUDERDAL, FL, 33322, US

(21) Appl. No.: 09/966,875

(22) Filed: Sep. 28, 2001

(51) Int. Cl. H04L 27/06

(52) U.S. Cl. 375/344

(57) ABSTRACT

A GMSK modulated signal has a voice/data signal minimum shift key (MSK) modulated in time slots of the carrier signal. A mixing signal is used to demodulate at least part of the voice/data signal from the carrier signal for each time slot. A plurality of amplitude and phases of the demodulated voice/data signal are converted into a plurality of received quadrature data. The received quadrature data is processed to determine a frequency slope error value, a binary cyclical redundancy check (CRC) value, an average signal-to-noise ratio (SNR) value, a received signal strength indicator (RSSI) value, and a sequence of digital bits forming at least part of the voice/data signal. The frequency slope error value is weighted with a first weighting value or a second weighting value when the binary CRC value is in its first binary state or its second binary state, respectively, to produce a weighted frequency slope error value. The first weighting value includes the combination of the SNR value and the RSSI value and the second weighting value zeroes the frequency slope error value. An average weighted frequency slope error value is determined for a plurality of time slots of the carrier signal. An average weight value is determined from the first weighting value and/or the second weighting value for the plurality of time slots. For each time slot, the average weighted frequency slope error value and the average weight value are combined to obtain an unweighted frequency error value. The unweighted frequency error value is utilized to adjust a frequency of the mixing signal to obtain frequency synchronization and frame synchronization with the GMSK modulated signal.

### BACKGROUND OF THE INVENTION

1. Field of the Invention

The present invention relates to a method of detecting a frequency offset of a linear, or approximately linear, modulation and, more particularly, to correcting for the frequency offset of such modulation.

2. Background Art

Currently, radios, such as cellular telephones, maintain synchronization with a serving cell and neighboring cells of a cellular radio network in two steps: (1) frequency and course timing synchronization are obtained for each cell by detecting the presence of and estimating the frequency offset of a signal transmitted over a frequency correction channel; and (2) fine timing and frame synchronization are obtained for each cell by decoding a signal transmitted over a frame synchronization channel. While this method of maintaining synchronization with the serving cell and neighboring cells is effective, it is also computationally expensive.

Alternatively, radios maintain frame synchronization with neighboring cells once frequency synchronization is achieved with the serving cell. In this approach, frequency synchronization is maintained only with the serving cell. This alternate method of maintaining synchronization is less complex because detection and estimation of neighboring cells' frequency correction channels are not performed after initial frame synchronization with the neighboring cells is achieved. This approach, however, has the disadvantage that under extreme Doppler shifts the receiver may not be able to reliably decode the neighboring cells synchronization channel.

It is desirable to avoid the computational expense and the inability to reliably decode neighboring cells synchronization channels under extreme Doppler shifts by providing a radio having an automatic frequency control (AFC) that obtains both frequency synchronization and frame synchronization with the serving cell and/or the neighboring cells from the synchronization channel.

### BRIEF DESCRIPTION OF THE DRAWINGS

FIG. 1 is a block diagram of an automatic frequency control (AFC) in accordance with the present invention; and

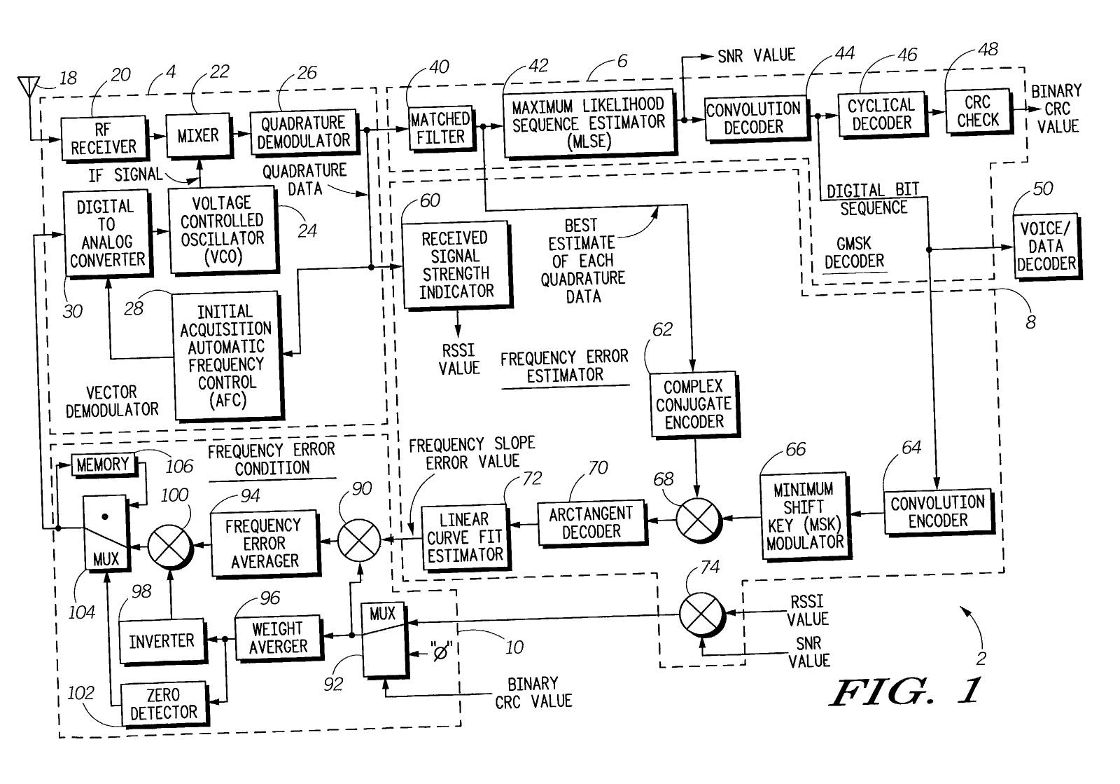

FIG. 2 is a flow chart diagram of a method for automatic frequency control in accordance with the present invention.

### DETAILED DESCRIPTION OF THE PREFERRED EMBODIMENT

With reference to the accompanying Figure, an automatic frequency control (AFC) 2 in accordance with the present invention includes a vector demodulator 4, a gaussian minimum shift key (GMSK) decoder 6, a frequency error estimator 8, and a frequency error conditioner 10. When used as part of a radio, such as a cellular telephone, AFC 2 enables the radio to obtain frequency synchronization and frame synchronization with a serving cell and/or neighboring cells of a cellular radio network from a synchronization channel.

Vector demodulator 4 includes a radio frequency (RF) receiver 20 connected to receive a GMSK modulated signal from an RF antenna 18. The GMSK modulated signal has a voice/data signal minimum shift key (MSK) modulated in one or more time slots of a carrier signal. A mixer 22 is connected to receive the GMSK modulated signal from RF receiver 20 and is connected to receive an intermediate frequency (IF) signal from a voltage control oscillator (VCO) 24. Mixer 22 combines the GMSK modulated signal and the IF signal to demodulate at least part of the voice/data signal from the carrier signal. A quadrature demodulator 26 is connected to receive the demodulated voice/data signal from mixer 22. Quadrature demodulator 26 converts a plurality of amplitude and phases of the demodulated voice/data signal into a like plurality of corresponding quadrature data.

An initial acquisition AFC 28 is connected to receive the received quadrature data from quadrature demodulator 26. Initial acquisition AFC 28 processes the received quadrature data in a manner known in the art to enable vector demodulator 4 to acquire carrier lock or frequency synchronization with the carrier signal part of the GMSK modulated signal. A digital-to-analog (D/A) converter 30 is connected to receive the digital output of initial acquisition AFC 28 and an output of frequency error conditioner 10 to be discussed hereinafter. D/A converter 30 combines the digital signals received from frequency error conditioner 10 and initial acquisition AFC 28 in a manner known in the art and supplies VCO 24 with an analog signal which adjusts the frequency of the IF signal supplied by VCO 24 to mixer 22.

RF receiver 20, IF mixer 22, VCO 24, quadrature demodulator 26, initial acquisition AFC 28, and D/A converter 30 are implemented in hardware that is configured to co-act in a manner known in the art to enable vector demodulator 4 to acquire carrier lock with the carrier signal part of the GMSK modulated signal. In contrast to the hardware elements of vector demodulator 4, however, the hereinafter described elements of GMSK decoder 6, frequency error estimator 8, and frequency error conditioner 10 are preferably implemented in software of a programmable digital controller, such as a microprocessor or a digital signal processor. GMSK decoder 6 includes a matched filter 40 connected to process the quadrature data output from quadrature demodulator 26. Matched filter 40 processes each quadrature data received from quadrature demodulator 26 to obtain a best estimate of the quadrature data filtered for noise and corrected for multi-path distortion. This best estimate is determined for each quadrature data of a time slot by comparing selected quadrature data obtained from the central portion of the time slot of quadrature data with predetermined reference quadrature data available to or stored in matched filter 40. More specifically, quadrature data in the central portion of each time slot is configured to include the predetermined reference quadrature data. It has been determined that often the quadrature data obtained from the central portion of a time slot becomes distorted for various reasons. To correct for this distortion, the quadrature data obtained from the central portion of each time slot is compared to the reference quadrature data. Based on this comparison, coefficients of matched filter 40 to correct for this distortion are determined. Matched filter 40 including these coefficients are then utilized to process the remaining quadrature data of the time slot to correct for noise and multi-path distortion.

The solution of matched filter 40 for each quadrature data, i.e., the best estimate of each received quadrature data, is supplied to a maximum likelihood sequence estimator (MLSE) 42 for processing. It is well known in the art of GMSK communication that a limited number, e.g., sixteen, ideal quadrature states can be obtained from a GMSK modulated signal passed through a dispersive channel. MLSE 42 compares the best estimate of each received quadrature data with this limited number of ideal quadrature states to determine for the best estimate of each quadrature data a best fit with one of the ideal quadrature states. Once a best fit is determined, MLSE 42 outputs the corresponding ideal quadrature state to convolution decoder 44 for processing. Thus, in response to receiving the best estimate of each received quadrature data, MLSE 42 outputs to convolution decoder 44 an ideal quadrature state representing a best fit between the best estimate of each received quadrature data and one of the ideal quadrature states.

A by-product of the algorithm implemented by MLSE 42 is that the comparison between the best estimate of each received quadrature data and the limited number of ideal quadrature states produces for each comparison a signal-to-noise ratio (SNR) value. When a best fit is determined for the best estimate of each quadrature data, a corresponding SNR value is also generated by MLSE 42. MLSE 42 averages the SNR values from the quadrature data for each time slot and outputs an average SNR value for the time slot for processing.

For each time slot, convolution decoder 44 converts ideal quadrature states output by MLSE 42 into a digital bit sequence having, among other things, twenty-five information bits and fourteen bits corresponding to a cyclical redundancy check or CRC reference value. A cyclical decoder 46 processes the twenty-five information bits to determine a CRC value. A CRC check 48 compares the CRC value determined by cyclical decoder 46 to the CRC reference value and generates a binary CRC value that is in a first state or a second state when a respective match or difference is detected between the CRC value output by cyclical decoder 46 and the reference CRC value.

The quadrature data output by quadrature demodulator 26, the best estimate of each quadrature data output by matched filter 40, and the digital bit sequence output by convolution decoder 44 for each time slot are supplied to frequency error estimator 8. In addition, the digital bit sequence output by convolution decoder 44 for each time slot is also supplied to a voice/data decoder 50 of a radio, such as a cellular telephone, for use in a manner known in the art.

Frequency error estimator 8 includes a received signal strength indicator 60 which determines from all or part of the quadrature data for each time slot the strength of the GMSK signal. More specifically, received strength signal indicator 60 determines for each time slot a received signal strength indicator (RSSI) value that is the sum of at least part of the quadrature data decoded for the time slot.

A complex conjugate encoder 62 determines the complex conjugate of the best estimate of each quadrature data output by matched filter 40 and a convolution encoder 64 converts the digital bit sequence output by convolution decoder 44 into ideal quadrature data. Each ideal quadrature data output by convolution encoder 64 corresponds to an ideal quadrature state output by MLSE 42. Each ideal quadrature data output by convolution encoder 64 is received by an MSK modulator 66 for MSK modulation thereof The complex conjugate of the best estimate of each quadrature data output by complex conjugate encoder 62 is combined by a multiplier 68 with the MSK modulated ideal quadrature data output by MSK modulator 66. Preferably, multiplier 68 combines the complex conjugate of each quadrature data with temporally corresponding MSK modulated ideal quadrature data. For example, multiplier 68 preferably combines the complex conjugate of the twenty-fifth sample of quadrature data obtained from a time slot with the twenty-fifth sample of MSK modulated ideal quadrature data for the same time slot. The solution generated by multiplier 68 is a quadrature difference data between the complex conjugate of each quadrature data and its corresponding MSK modulated ideal quadrature data.

An arctangent decoder 70 decodes each quadrature difference data into phase data having a normalized amplitude. A linear curve fit estimator 72 receives the solution output by arctangent decoder 70 for each quadrature difference data output by multiplier 68. Linear curve fit estimator 72 implements a curve fitting algorithm, such as a least squares curve fit, to determine a frequency slope error value from the phase data output by arctangent decoder 70 for each time slot. The frequency slope error value output by linear curve fit estimator 72 for each time slot corresponds to a frequency difference between the frequency of each received time slot and the frequency of the IF signal output by VCO 24.

Frequency error estimator 8 also includes a multiplier 74 connected to combine the SNR value output by MLSE 42 and the RSSI value output by received signal strength indicator 60.

Frequency error conditioner 10 includes a multiplier 90 and multiplexer 92. Multiplexer 92 is connected to receive the solution of multiplier 74 and the binary CRC value output by CRC check 48. When the CRC value is in the first binary state, corresponding to CRC check 48 detecting a match, multiplexer 92 supplies the solution of multiplier 74 to multiplier 90. Multiplier 90 is also connected to receive for each time slot the frequency slope error value output by linear curve fit estimator 72.

The solution generated by multiplier 74 represents a weighting value that is utilized to weight the reliability of the frequency slope error value for each time slot. Thus, if multiplier 74 receives a relatively high value of RSSI and a relatively high value of SNR corresponding to a strong signal and a relatively accurate comparison by MLSE 42, respectively, the frequency slope error value is weighted more heavily indicating a greater degree of confidence that the frequency slope error value is correct. In contrast, if the value of RSSI and/or SNR is lower the weighting applied to the frequency slope error value for the time slot is lower, indicating a lesser degree of confidence that the frequency slope error value is correct.

If the CRC value output by CRC check 48 is in the second binary state, corresponding to CRC check 48 detecting a difference, multiplexer 92 supplies a value of zero to multiplier 90. This value of zero when combined by multiplier 90 with the frequency slope error value for the time slot indicates for the time slot that there is no confidence that the frequency slope error value is correct.

The solution of multiplier 90 for each time slot is provided to a weighted frequency error value averager 94 which averages the weighted frequency slope error value for a plurality of time slots. Similarly, the output of multiplexer 92 is supplied to a weight averager 96 which averages the weights supplied to multiplier 90 over the same plurality of time slots.

The output of weight averager 96 is supplied to an inverter 98 and a zero detector 102. For each time slot, a multiplier 100 receives the solution of inverter 98 and the solution of weighted frequency error value averager 94. The solution generated by multiplier 100 for each time slot is an unweighted frequency error value average.

Preferably, for each time slot, the unweighted frequency error value average output by multiplier 100 is supplied to D/A converter 30 of vector demodulator 4 via a multiplexer 104. However, under a certain condition described hereinafter D/A converter 30 receives a value of zero from multiplexer 104. Specifically, multiplexer 104 has an input connected to an output of zero detector 102 which is in a first binary state when the solution of weight averager 96 is greater than zero and which is in the second binary state when the solution of weight averager 96 equals zero. When the output of zero detector 102 is in the first binary state, the unweighted frequency error value average is supplied to D/A converter 30 as described above. A memory 106 connected between the output of multiplexer 104 and another input thereof stores the value of the unweighted frequency error value average output by multiplier 100.

If, however, the solution of weight averager 96 is zero, the output of zero detector 102 changes to the second binary state causing multiplexer 104 to connect the output of memory 106 to the input of D/A converter 30. Thus, when the solution of weight averager 96 is greater than zero, the unweighted frequency error value average output by multiplier 100 is supplied to D/A converter 30. In contrast, if the solution of weight averager 96 is zero, a stored value of the unweighted frequency error value average is supplied from memory 106 to D/A converter 30 for each time slot during which the solution of weight averager 96 is zero. Preferably, the unweighted frequency error value average stored in memory 106 is updated with a new value for each time slot when the solution of weight averager 96 is greater than zero.

D/A converter 30 combines the output of frequency error conditioner 10 and the output of initial acquisition AFC 28 to produce an analog signal which causes VCO 24 to adjust the frequency of the IF signal provided to mixer 22 to compensate for any frequency difference between the GMSK modulated signal and the IF signal output by VCO 24.

By compensating for such a frequency difference, AFC 2 corrects for frequency error of GMSK modulated signals transmitted over time-dispersive channels and enables a radio to obtain and maintain frequency synchronization and frame synchronization from a synchronization channel.

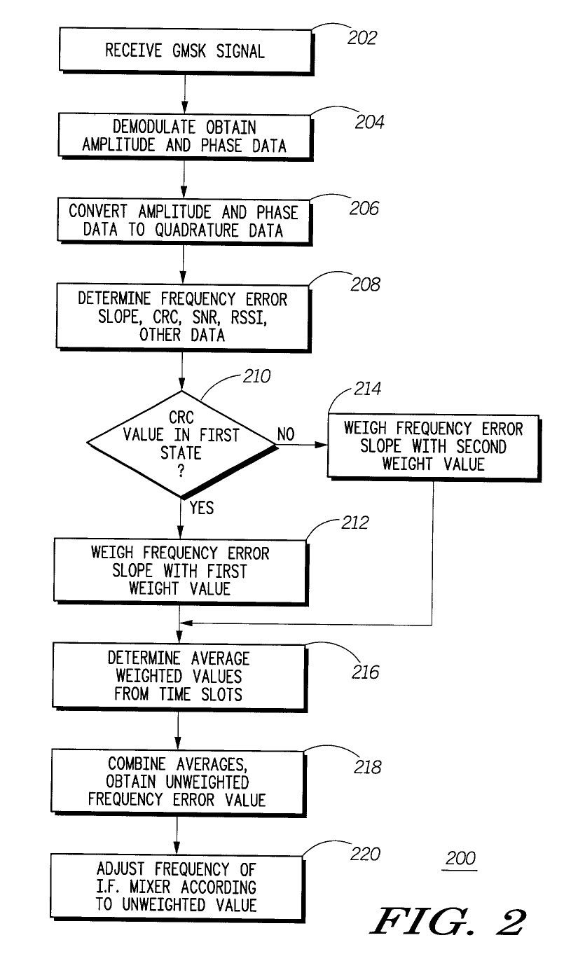

Referring now to FIG. 2, there is a shown a flow chart diagram 200 of a method for automatic frequency control in accordance with the present invention. In particular the method is a method of automatic frequency control of gaussian minimum shift key (GMSK) modulated signals transmitted over time-dispersive channels. The method begins first upon receiving a GMSK modulated signal having a voice/data signal minimum shift key (MSK) modulated in time slots of a carrier signal (202). For each time slot, utilizing a mixing signal to demodulate at least part of the voice/data signal from the carrier signal (204). The device performing the method then begins converting a plurality of amplitude and phases of the demodulated voice/data signal into a like plurality of received quadrature data (206). From the quadrature data the device can derive a frequency error slope value, a binary cyclical redundancy check (CRC) value, an average signal-to-noise ratio (SNR) value, a received signal strength indicator (RSSI) value, and a sequence of digital bits forming at least part of the voice/data signal (208). The device then determines if the CRC value is in a first binary state or a second binary state (210). The frequency slope error value is then weighted with a first weighting value (212) or a second weighting value (214) when the binary CRC value is in a first binary state or a second binary state, respectively, to produce a weighted frequency slope error value, with the first weighting value including the combination of the average SNR value and the RSSI value, and with the second weighting value zeroing the frequency slope error value. After the weighting is done, the device commences determining an average weighted frequency slope error value for a plurality of time slots of the carrier signal (216), and determining an average weighting value from the first weighting value and/or the second weighting value for the plurality of time slots (216). These averages are combined to obtain an unweighted frequency error value (218). The method then allows adjusting the frequency of the mixing signal as a function of the unweighted frequency error value (220).

The invention has been described with reference to the preferred embodiment. Obvious modifications and alterations will occur to others upon reading and understanding the preceding detailed description. For example, while the elements associated with reference numbers 40-48, 60-74 and 90-106 of GMSK decoder 6, frequency error estimator 8 and frequency error conditioner 10, respectively, have been described as implemented in software of a digital controller, one or more of these elements could be implemented in digital hardware and/or combination of digital hardware and software. It is intended that the invention be construed as including all such modifications and alterations insofar as they come within the scope of the appended claims or the equivalents thereof.

What is claimed is:

1. A method of automatic frequency control of gaussian minimum shift key (GMSK) modulated signals transmitted over time-dispersive channels, the method comprising the steps of:
(a) receiving a GMSK modulated signal having a voice/data signal minimum shift key (MSK) modulated in time slots of a carrier signal;
(b) for each time slot, utilizing a mixing signal to demodulate at least part of the voice/data signal from the carrier signal;
(c) converting a plurality of amplitude and phases of the demodulated voice/data signal into a like plurality of received quadrature data;
(d) determining from the plurality of received quadrature data a frequency error slope value, a binary cyclical redundancy check (CRC) value, an average signal-to-noise ratio (SNR) value, a received signal strength indicator (RSSI) value, and a sequence of digital bits forming at least part of the voice/data signal;
(e) weighting the frequency slope error value with a first weighting value or a second weighting value when the binary CRC value is in a first binary state or a second binary state, respectively, to produce a weighted frequency slope error value, with the first weighting value including the combination of the average SNR value and the RSSI value, with the second weighting value zeroing the frequency slope error value;
(f) determining an average weighted frequency slope error value for a plurality of time slots of the carrier signal; determining an average weighting value from the first weighting value and/or the second weighting value for the plurality of time slots;
(h) combining the averages determined in step (f) and step (g) to obtain an unweighted frequency error value; and
(i) adjusting a frequency of the mixing signal as a function of the unweighted frequency error value.

2. The method as set forth in claim 1, wherein:
the average SNR value is obtained by averaging a plurality of SNR values;
each SNR value is determined from a comparison of a best estimate of a corresponding one of each received quadrature data with one of a plurality of ideal quadrature states; and
the best estimate of each received quadrature data is determined by filtering each received quadrature data for noise and correcting each received quadrature data for multi-path distortion.

3. The method as set forth in claim 1, wherein the RSSI value is determined by combining at least part of the plurality of received quadrature data.

4. The method as set forth in claim 1, wherein the binary CRC value is in the first binary state or the second binary state when a respective match or difference is detected between a reference CRC value and a combination at least part of the sequence of digital bits.

5. The method as set forth in claim 1, wherein each frequency error slope value is determined by combining a best estimate of each quadrature data with an ideal quadrature data corresponding to at least one digital bit in the sequence of digital bits, where the best estimate of each quadrature data is determined by filtering each received quadrature data for noise and correcting each received quadrature data for multi-path distortion.

6. The method as set forth in claim 1, further including the steps of:
(j) storing an unweighted frequency slope value;
(k) after step (j), detecting when the average determined in step (g) is zero; and
(l) in response to detecting when the average determined in step (g) is zero, adjusting the frequency of the mixing signal as a function of the stored unweighted frequency error value.

7. The method as set forth in claim 1, wherein determining the frequency error slope value in step (d) includes the steps of:
(d1) MSK modulating each bit of the sequence of digital bits to obtain ideal quadrature data equivalents thereof;
(d2) filtering each quadrature data for noise and correcting each received quadrature data for multi-path distortion to obtain a best estimate for each received quadrature data;
(d3) determining a complex conjugate of the best estimate of each received quadrature data;
(d4) combining each complex conjugate with its temporally corresponding ideal quadrature data equivalent to obtain a corresponding frequency error quadrature data;
(d5) determining an arctangent value of each frequency error quadrature data;
(d6) storing each arctangent value; and
(d7) determining the frequency error slope value from the stored arctangent values.

8. The method as set forth in claim 7, wherein:
step (d6) includes storing each arctangent value in time order; and
step (d7) includes utilizing a linear curve fitting algorithm to process the stored arctangent values to obtain the frequency error slope value.
